(19) United States
(12) Patent Application Publication
(10) Pub. No.: US 2026/0196424 A1
(43) Pub. Date: Jul. 9, 2026

(54) ROTARY KNOB DEVICE

(71) Applicants: ICHIA TECHNOLOGY (SUZHOU) CO., LTD., SUZHOU (CN); ICHIA TECHNOLOGIES, INC., Taoyuan City (TW)

(72) Inventors: CHUNG-CHING CHOU, TAOYUAN CITY (TW); CHUNG-YU CHEN, TAOYUAN CITY (TW)

(21) Appl. No.: 19/192,285

(22) Filed: Apr. 28, 2025

(30) Foreign Application Priority Data
Jan. 9, 2025 (CN) 202510037967.5

(51) Int. Cl. H01H 19/14; H01H 19/03; H01H 19/08; H01H 19/52

(52) U.S. Cl. CPC H01H 19/14; H01H 19/03; H01H 19/08; H01H 19/52

(57) ABSTRACT

A rotary knob device includes a seat, an operation cover, an annular circuit board, a braking ring, a resistance component, and a plurality of elastic components, conductive trigger components, and reset conductive components. The operation cover is pivotally mounted on the seat. The annular circuit board is disposed in the seat. The braking ring is fixed on the annular circuit board and connected to the operation cover. The resistance component is fixed on the seat and abuts against the braking ring. The elastic components are disposed on the braking ring or the annular circuit board. The conductive trigger components are fixed on the operation cover. The reset conductive components are disposed on the braking ring. When the operation cover is pressed, the conductive trigger component compresses the elastic component. When the operation cover is released, the elastic component pushes the conductive trigger component away.

### CROSS-REFERENCE TO RELATED PATENT APPLICATION

This application claims the benefit of priority to China Patent Application No. 202510037967.5, filed on Jan. 9, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a device, and more particularly to a rotary knob device.

### BACKGROUND OF THE DISCLOSURE

A conventional rotary knob device can trigger the touch function display panel by conducting charges from the human body. However, the conventional rotary knob device often triggers the touch function display panel even before being touched by a human, thereby causing unintended signals to enter the touch function display panel. In other words, the conventional rotary knob device is susceptible to electromagnetic interference from the environment or static electricity, leading to the occurrence of ghost touch or false touch phenomena.

### SUMMARY OF THE DISCLOSURE

In response to the above-referenced technical inadequacy, the present disclosure provides a rotary knob device.

In order to solve the above-mentioned problems, one of the technical aspects adopted by the present disclosure is to provide a rotary knob device. The rotary knob device includes a seat, an operation cover, an annular circuit board, a braking ring, a resistance component, a plurality of elastic components, a plurality of conductive trigger components, and a plurality of reset conductive components. The seat can be installed on a touch function display panel, and the seat includes an external conductive component and defines a thickness direction. The operation cover is pivotally connected on the seat. The operation cover can rotate relative to the seat and move along the thickness direction between a trigger position and a release position. The annular circuit board is disposed in the seat. The annular circuit board has a plurality of contact points arranged in an annular configuration. The braking ring is fixed on the annular circuit board and connected to the operation cover. The braking ring can be driven by the operation cover to rotate relative to the seat. The resistance component is fixed on the seat and abuts against the braking ring. The elastic components are disposed on at least one of the braking ring or the annular circuit board. The conductive trigger components are fixed on a side of the operation cover facing the seat. The conductive trigger components respectively correspond in position to the elastic components. The reset conductive components are disposed on the braking ring. The reset conductive components respectively correspond in position to the conductive trigger components, and each of the reset conductive components is spaced apart from at least one of the conductive trigger components or the external conductive component. When the operation cover is at the trigger position, the conductive trigger components compress the elastic components to generate an elastic force, and the conductive trigger components respectively push against the reset conductive components to electrically couple with the external conductive component, so that a charge from the operation cover is configured to be conducted to the external conductive component. When the operation cover is at the release position, the elastic components release the elastic force to push against the conductive trigger components, so as to separate the reset conductive components.

Therefore, in the rotary knob device provided by the present disclosure, by virtue of “the operation cover being configured to rotate relative to the seat and move along the thickness direction between a trigger position and a release position, and each of the reset conductive components being spaced apart from at least one of a corresponding one of the conductive trigger components or the external conductive component,” “when the operation cover is at the trigger position, the conductive trigger components compressing the elastic components to generate an elastic force, and the conductive trigger components respectively pushing against the reset conductive components to electrically couple with the external conductive component, so that a charge from the operation cover is conducted to the external conductive component,” and “when the operation cover is at the release position, the elastic components releasing the elastic force to push against the conductive trigger components, so as to separate the reset conductive components,” the rotary knob device can prevent the ghost touch or false touch phenomena from occurring.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a rotary knob device according to the present disclosure;

FIG. 2 is another schematic perspective view of the rotary knob device according to the present disclosure;

FIG. 3 is a schematic exploded view of the rotary knob device according to the present disclosure;

FIG. 4 is another schematic exploded view of the rotary knob device according to the present disclosure;

FIG. 5 is a schematic exploded view of an external conductive component according to the present disclosure;

FIG. 6 is a schematic cross-sectional view taken along line VI-VI of FIG. 2;

FIG. 7 is a schematic cross-sectional view taken along line VII-VII of FIG. 2;

FIG. 8 is a schematic cross-sectional view taken along line VIII-VIII of FIG. 1;

FIG. 9 is a schematic enlarged view of part of FIG. 8; and

FIG. 10 is a schematic view of an operation cover at a trigger position according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

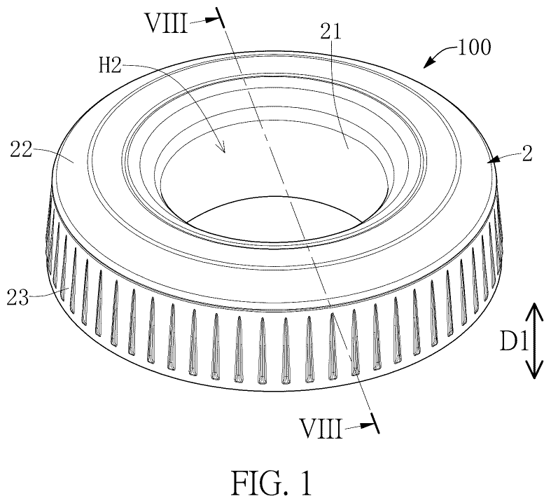

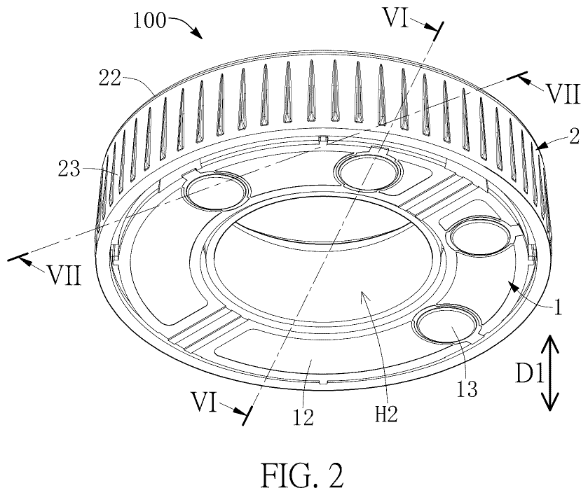

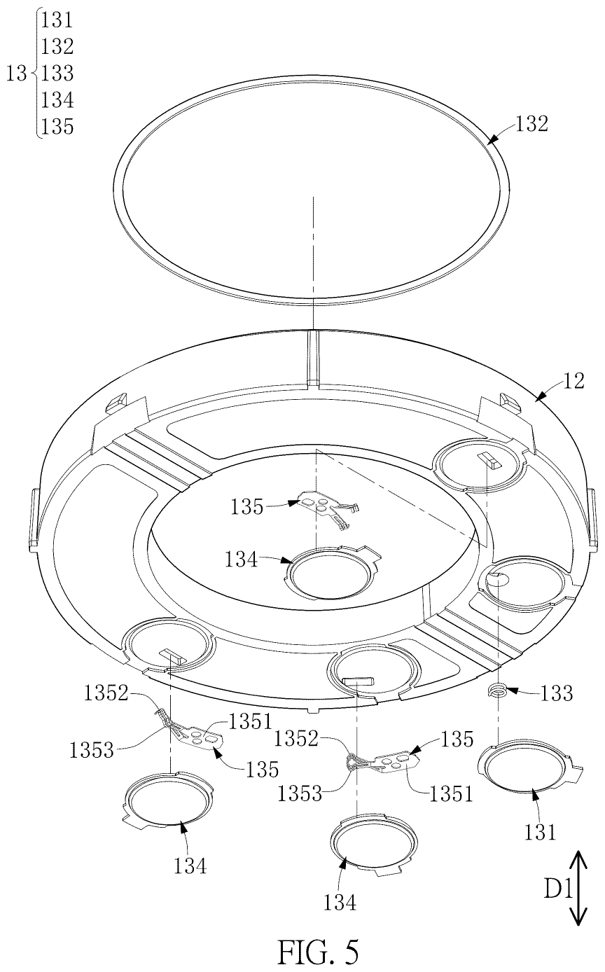

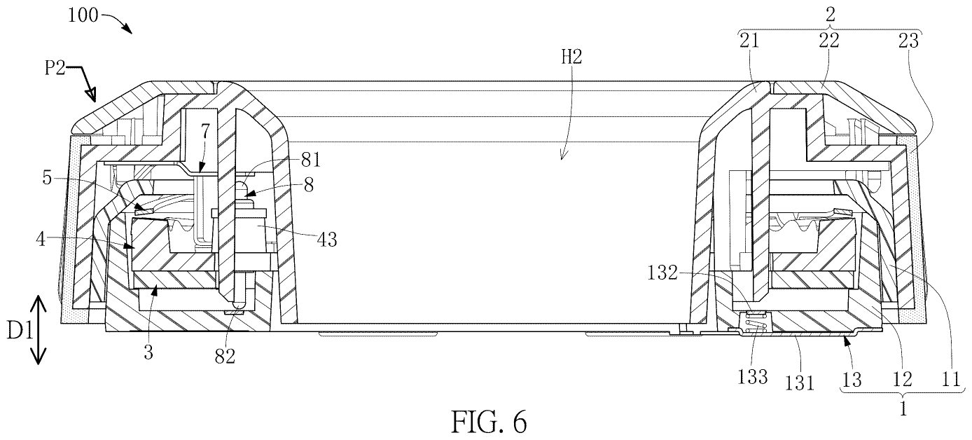

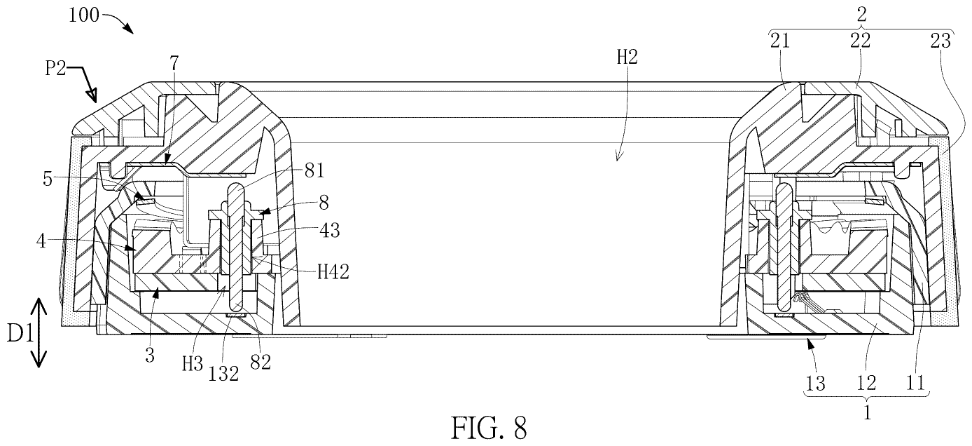

Referring to FIG. 1 to FIG. 10, the present disclosure provides a rotary knob device 100, and the rotary knob device 100 is configured to be installed on a touch function display panel (not shown). In practice, the operational signals sent by the rotary knob device 100 are recognized and responded to through an application in the touch function display panel. Since the recognition and response between the rotary knob device 100 and the touch function display panel are known to those skilled in the art and are not the focus of the present disclosure, details thereof will not be described herein.

Referring to FIG. 1 to FIG. 3, the rotary knob device 100 includes a seat 1, an operation cover 2 pivotally mounted on the seat 1, an annular circuit board 3 disposed in the seat 1, a braking ring 4 fixed on the annular circuit board 3 and connected to the operation cover 2, a resistance component 5 fixed on the seat 1 and abutting against the braking ring 4, a plurality of elastic components 6 disposed on at least one of the braking ring 4 or the annular circuit board 3, a plurality of conductive trigger components 7 fixed on a side surface of the operation cover 2 facing the seat 1, and a plurality of reset conductive components 8 that are disposed on the braking ring 4. The following description describes the structure and connection relation of each component of the rotary knob device 100.

Referring to FIG. 1 to FIG. 4, the seat 1 in the present embodiment is made of an insulating material and includes an upper component 11 and a lower component 12 that are assembled together, but the present disclosure is not limited thereto. Additionally, for the convenience of subsequent descriptions, a thickness direction D1 is defined for the seat 1.

The seat 1 has a viewing hole H2 along the thickness direction D1, the viewing hole H2 can allow an icon of the touch function display panel to be displayed (i.e., an operator can see the icon of the touch function display panel through the viewing hole). The viewing hole H2 is preferably located at a central area of the seat 1, but the present disclosure is not limited thereto. For example, in another embodiment of the present disclosure (not shown), the viewing hole H2 may be omitted.

Additionally, the seat 1 further includes an external conductive component 13, and the external conductive component 13 serves as a final circuit path for triggering the touch function display panel.

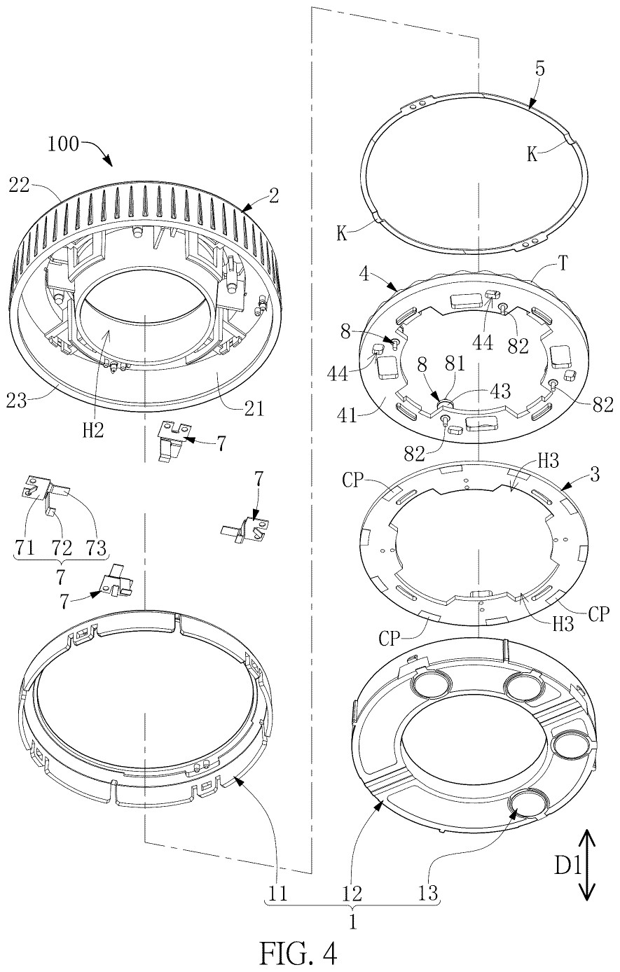

Referring to FIG. 4 to FIG. 6, the external conductive component 13, in response to the pressing operation of the operation cover 2, may include a first exposed pad 131, a conductive ring 132, and a first conductive bridging component 133 that are disposed on the lower component 12. The first exposed pad 131 is disposed on a side surface of the lower component 12 away from the operation cover 2, and the conductive ring 132 is disposed on the seat 1.

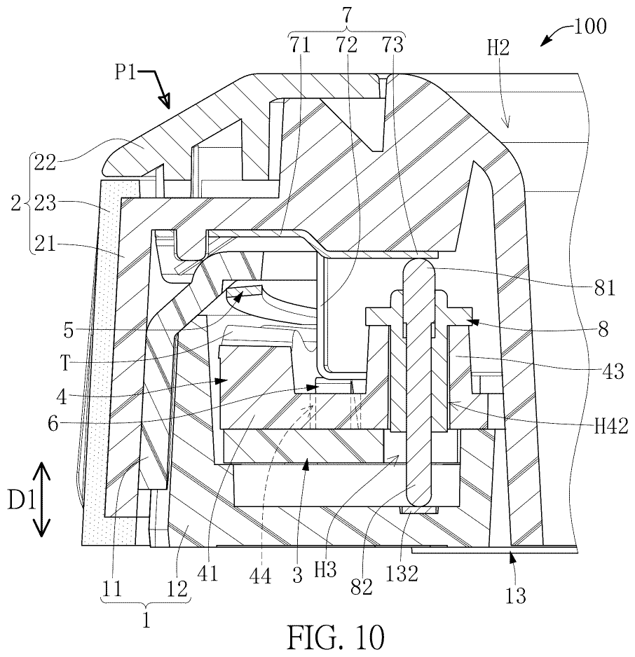

Additionally, the first conductive bridging component 133 is disposed between the conductive ring 132 and the first exposed pad 131, and the first conductive bridging component 133 is electrically coupled to the conductive ring 132 and the first exposed pad 131. Therefore, when the operation cover 2 is pressed (i.e., as shown in FIG. 10, when the operation cover 2 is at a trigger position P1), the reset conductive components 8 can contact the conductive ring 132 to trigger the touch function display panel through the conductive ring 132 and the first exposed pad 131 (described in more detail later).

Preferably, the first conductive bridging component 133 may be a conductive compression spring to ensure an electrical reliability between the conductive ring 132 and the first exposed pad 131.

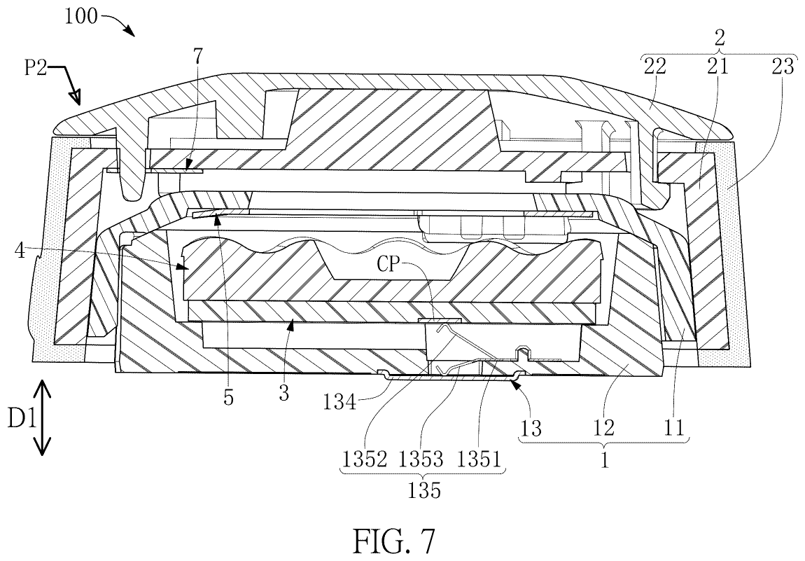

Referring to FIG. 4, FIG, 5, and FIG. 7, the external conductive component 13, in response a rotational operation of the operation cover 2, may include a plurality of second exposed pads 134 and a plurality of second conductive bridging components 135 that are disposed on the lower component 12. The second exposed pads 134 are disposed on a side surface of the lower component 12 away from the operation cover 2 and are spaced apart from each other. The second conductive bridging components 135 are disposed between the second exposed pads 134 and the contact points CP of the annular circuit board 3. Each of the second conductive bridging components 135 can electrically couple at least one of the contact points CP and at least one of the second exposed pads 134. Accordingly, when the operation cover 2 rotates relative to the seat 1, at least one of the contact points CP is electrically coupled to one of the second exposed pads 134 through one of the second conductive bridging components 135.

To ensure that each of the second conductive bridging components 135 can stably and non-fixedly electrically couple at least one of the contact points CP and at least one of the second exposed pads 134, each of the second conductive bridging components 135 may include a fixing plate 1351, and a first contact claw 1352 and a second contact claw 1353 that are connected to the fixing plate 1351. The fixing plate 1351 is fixed on the lower component 12, so that the second conductive bridging component 135 does not rotate with the operation cover 2. Moreover, the first contact claw 1352 extends from the fixing plate 1351 toward the annular circuit board 3, and an end of the first contact claw 1352 is elastically abutted against one of the contact points CP to electrically couple with one of the contact points CP. The second contact claw 1353 extends from the fixing plate 1351 toward the seat 1, and an end of the second contact claw 1353 is elastically abutted against one of the second exposed pads 134. That is, the first contact claw 1352 and the second contact claw 1353 can jointly form an opening having a gradually expanding configuration.

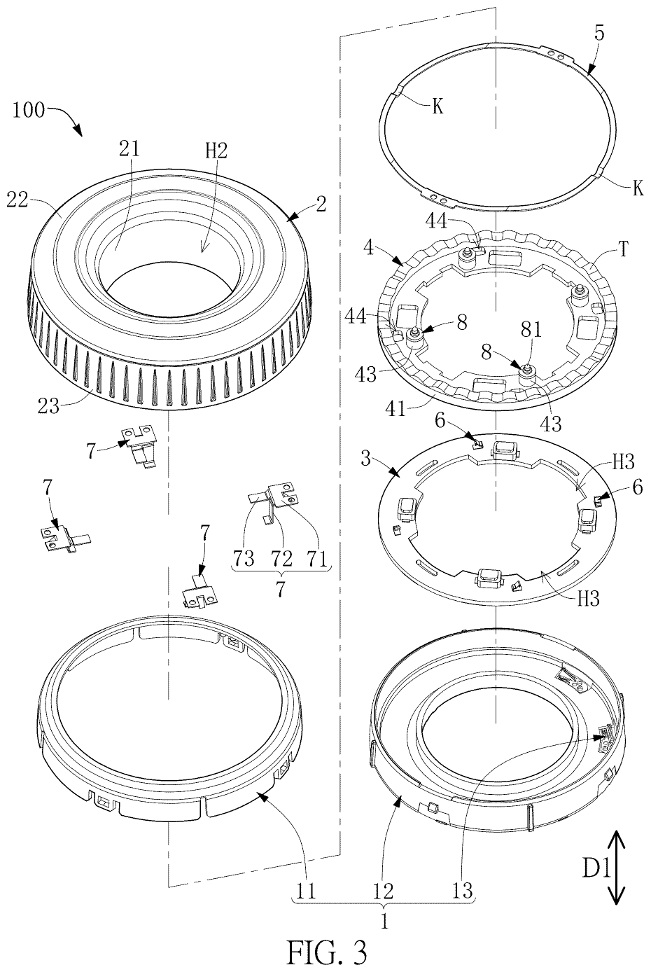

Referring to FIG. 3, FIG, 9, and FIG. 10, to perform both pressing and rotational operations, the operation cover 2 can rotate relative to the seat 1 and move along the thickness direction D1 between a trigger position P1 and a release position P2.

Specifically, the operation cover 2 includes a support base 21, a conductive outer cover 22 disposed on the support base 21, and a non-slip sleeve 23. The support base 21 is pivotally mounted on the upper component 11 (i.e., a portion of the upper component 11 is located in the support base 21), and the support base 21 can be assembled with the braking ring 4, so that the support base 21 can drive the braking ring 4 to rotate relative to the seat 1.

A plurality of conductive pins (not shown) of the conductive outer cover 22 pass through a side surface of the support base 21 facing the seat, so that the conductive pins are positioned between the braking ring 4 and the support base 21 to electrically couple with the conductive trigger components 7.

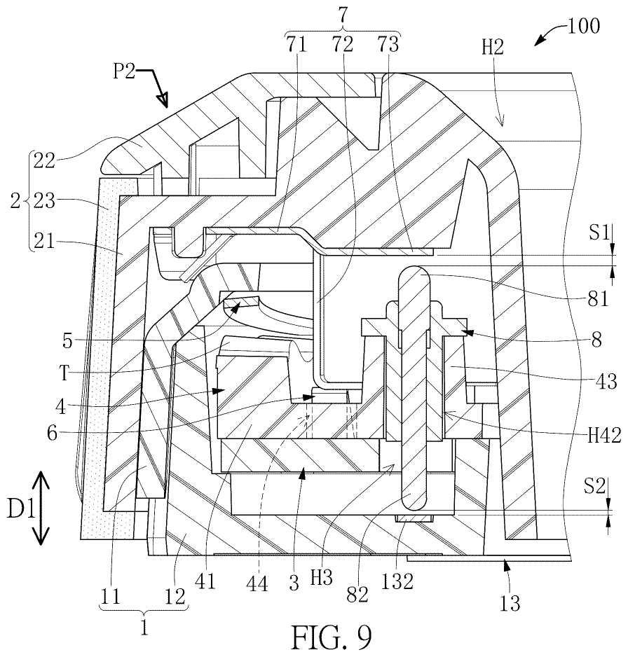

Referring to FIG. 3, FIG, 4, and FIG. 9, the braking ring 4 can cooperate with the resistance component 5, so that the operation cover 2 can be assembled onto the seat 1. Specifically, the braking ring 4 includes a main body 41, a plurality of through holes H42, and a plurality of annular posts 43. The main body 41 is annular in shape. Each of the through holes H42 extends through the main body 41 along the thickness direction D1, and the through holes H42 are arranged in an annular configuration on the main body 41. Additionally, the annular posts 43 are respectively sleeved on the through holes H42 to accommodate the reset conductive components 8. That is, the annular posts 43 are also arranged in an annular configuration.

In particular, when the rotary knob device 100 is operated in a rotational manner, the braking ring 4 cooperates with the resistance component 5 to provide an appropriate resistance tactile feedback. Specifically, the resistance component 5 is fixed on the upper component 11 and is located in the support base 21. The resistance component 5 corresponds in position to the braking ring 4. The main body 41 of the braking ring 4 has a plurality of teeth T arranged in an annular configuration on a side surface opposite to the lower component 12. The teeth T face the resistance component 5, so that a protrusion K of the resistance component 5 can abut against any one of the teeth T of the braking ring 4, so as to be temporarily restricted from rotating. Therefore, when the operation cover 2 is subjected to a rotational force exceeding a threshold, the protrusion K can move over the teeth T, so as to provide a tactile detent feedback during rotation.

Referring to FIG. 3, FIG. 4, and FIG. 9, in the present embodiment, the annular circuit board 3 is fixed on a side surface of the braking ring 4 facing the seat, and the annular circuit board 3 can be driven by the braking ring 4 to rotate relative to the seat 1. The annular circuit board 3 has a plurality of contact points CP arranged in an annular configuration, the contact points CP are used for signal determination during the rotational operation of the rotary knob device 100. Moreover, the annular circuit board 3 has a plurality of clearance holes H3, the clearance holes H3 can allow the reset conductive components 8 to pass through. When the operation cover 2 is pressed, charges can be conducted to the touch function display panel through the conductive trigger components 7 and the reset conductive components 8.

Further referring to FIG. 3, FIG. 4, and FIG. 9, the elastic components 6 can provide resilient support for the conductive trigger components 7, so that the operation cover 2 can move from the trigger position P1 to the release position P2. In the present embodiment, the elastic components 6 are disposed in the mounting grooves 44 of the braking ring 4. That is, the elastic components 6 are positioned on the annular circuit board 3. Specifically, the braking ring 4 further includes the mounting grooves 44 disposed on the main body 41. The plurality of mounting grooves 44 are in spatial communication with the surface of the annular circuit board 3 along the thickness direction D1 and are respectively adjacent to the annular posts 43. Accordingly, when the conductive trigger components 7 are mounted on the elastic components 6, the conductive trigger components 7 can be positioned adjacent to the plurality of reset conductive components 8.

Referring to FIG. 3, FIG. 4, and FIG. 9, the conductive trigger components 7 are fixed on the operation cover 2 and electrically coupled to the conductive outer cover 22 of the operation cover 2. Additionally, the conductive trigger components 7 respectively correspond in position to the elastic components 6.

In the present embodiment, each of the conductive trigger components 7 includes a fixing plate 71, and a reset plate 72 and a trigger plate 73 that are connected to the fixing plate 71. The fixing plate 71 is arranged substantially perpendicular to the thickness direction D1 and is assembled to a side surface of the operation cover 2 facing the seat 1. Additionally, the fixing plate 71 can be connected to the conductive pins to receive charge.

Additionally, in the present embodiment, a cross-sectional shape of the reset plate 72 is generally L-shaped. The reset plate 72 extends from the fixing plate 71 along the thickness direction D1, so that a portion of the reset plate 72 (i.e., an end portion perpendicular to the thickness direction D1) corresponds in position to one of the elastic components 6. Furthermore, the trigger plate 73 is generally parallel to the fixing plate 71, the trigger plate 73 extends from the fixing plate 71 and is positioned on one side of the reset plate 72. A portion of the trigger plate 73 corresponds in position to one of the reset conductive components 8.

Therefore, when the operation cover 2 is at the trigger position P1, each of the reset plates 72 compresses a corresponding one of the elastic components 6 to generate the elastic force, and the trigger plates 73 respectively push against the reset conductive components 8 to conduct charges to the external conductive component 13. Conversely, when the operation cover 2 is at the release position P2, the elastic components 6 release the elastic force to push against the reset plates 72, so that the trigger plates 73 move away from the reset conductive components 8 to prevent charge transmission.

Further referring to FIG. 3, FIG. 4, and FIG. 9, the reset conductive components 8 respectively correspond in position to the conductive trigger components 7. The reset conductive components 8 can respectively pass through the clearance holes H3 to selectively abut against and conduct charge to the external conductive component 13.

In other words, when the operation cover 2 is at the release position P2, each of the reset conductive component 8 is spaced apart from at least one of a corresponding one of the conductive trigger components 7 or the external conductive component 13, so that the charge on the operation cover 2 cannot be conducted to the external conductive component through the reset conductive components 8. Conversely, when the operation cover 2 is at the trigger position P1, the reset conductive components 8 receive the charges through the conductive trigger components and further conduct the charges to the external conductive component 13.

Preferably, each of the reset conductive components 8 is spaced apart from a corresponding one of the conductive trigger components 7 and the external conductive component 13. Additionally, a shortest gap S1 along the thickness direction D1 between each of the reset conductive components 8 and a corresponding one of the conductive trigger components 7 (specifically, the trigger plate 73) can be greater than or equal to 0.3 mm, so as to reduce the risk of erroneous detection when the operation cover 2 is rotated. Furthermore, a shortest gap S2 along the thickness direction D1 between each of the reset conductive components 8 and the external conductive component 13 (specifically, the conductive ring 132) can also be designed to be greater than or equal to 0.1 mm, so as to achieve air isolation to reduce coupling effects.

In practice, the reset conductive components 8 are a plurality of dual-headed spring pins. Each of the dual-headed spring pins can be fixed on the annular post 43 and pass through the through hole H42. A first end 81 of each of the dual-headed spring pins can be pushed by the conductive trigger component, so that a second end 82 of each of the dual-headed spring pins can pass through the clearance hole H3 and be electrically coupled to the external conductive component 13, but the present disclosure is not limited thereto.

For example, in another embodiment of the present disclosure (not shown), each of the reset conductive components 8 may also be a conductive spring plate connected to the conductive trigger component 7. The conductive spring plate has a first portion corresponding in position to the elastic component 6 and a second portion that corresponds in position to the conductive ring 132. Accordingly, when the operation cover 2 is at the trigger position P1, each of the conductive trigger components 7 drives the first portion to compress a corresponding one of the elastic components 6, so as to generate the elastic force, and each of the second portions contacts the conductive ring 132 for electrical coupling.

### Beneficial Effects of the Embodiment

In conclusion, in the rotary knob device provided by the present disclosure, by virtue of “the operation cover being configured to rotate relative to the seat and move along the thickness direction between a trigger position and a release position, and each of the reset conductive components being spaced apart from at least one of a corresponding one of the conductive trigger components or the external conductive component,” “when the operation cover is at the trigger position, the conductive trigger components compressing the elastic components to generate an elastic force, and the conductive trigger components respectively pushing against the reset conductive components to electrically couple with the external conductive component, so that a charge from the operation cover is conducted to the external conductive component,” and “when the operation cover is at the release position, the elastic components releasing the elastic force to push against the conductive trigger components, so as to separate the reset conductive components,” the rotary knob device can prevent the ghost touch or false touch phenomena from occurring.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A rotary knob device, comprising:
a seat configured to be installed on a touch function display panel, the seat including an external conductive component and defining a thickness direction;
an operation cover pivotally connected on the seat, wherein the operation cover is configured to rotate relative to the seat and move along the thickness direction between a trigger position and a release position;
an annular circuit board disposed in the seat, wherein the annular circuit board has a plurality of contact points arranged in an annular configuration;
a braking ring fixed on the annular circuit board and connected to the operation cover, wherein the braking ring is configured to be driven by the operation cover to rotate relative to the seat;
a resistance component fixed on the seat and abutting against the braking ring;
a plurality of elastic components disposed on at least one of the braking ring or the annular circuit board;
a plurality of conductive trigger components fixed on a side of the operation cover facing the seat, wherein the conductive trigger components respectively correspond in position to the elastic components;
a plurality of reset conductive components disposed on the braking ring, wherein the reset conductive components respectively correspond in position to the conductive trigger components, and each of the reset conductive components is spaced apart from at least one of a corresponding one of the conductive trigger components or the external conductive component;
wherein, when the operation cover is at the trigger position, the conductive trigger components compress the elastic components to generate an elastic force, and the conductive trigger components respectively push against the reset conductive components to electrically couple with the external conductive component, so that a charge from the operation cover is configured to be conducted to the external conductive component; wherein, when the operation cover is at the release position, the elastic components release the elastic force to push against the conductive trigger components, so as to separate the reset conductive components.

2. The rotary knob device according to claim 1, wherein each of the reset conductive components is spaced apart from a corresponding one of the conductive trigger components and the external conductive component.

3. The rotary knob device according to claim 2, wherein a shortest gap between each of the reset conductive components and a corresponding one of the conductive trigger components along the thickness direction is greater than or equal to 0.3 mm, and a shortest gap between each of the reset conductive components and the external conductive component along the thickness direction is greater than or equal to 0.1 mm.

4. The rotary knob device according to claim 1, wherein each of the conductive trigger components includes:
a fixing plate assembled on a side of the operation cover facing the seat;
a reset plate extending from the fixing plate, wherein a portion of the reset plate corresponds in position to one of the elastic components; and
a trigger plate extending from the fixing plate and located on one side of the reset plate, wherein a position of the trigger plate corresponds in position to one of the reset conductive components;
wherein, when the operation cover is at the trigger position, each of the reset plate compresses a corresponding one of the elastic components to generate the elastic force, so that the trigger plates respectively push against the reset conductive components to electrically couple with the external conductive component; wherein, when the operation cover is at the release position, the elastic components release the elastic force to push against a plurality of reset plates, so that the trigger plates move away from the reset conductive components.

5. The rotary knob device according to claim 1, wherein the external conductive component includes:
a first exposed pad disposed on a side surface of the seat that is opposite to the operation cover;
a conductive ring disposed on the seat; and
a first conductive bridging component disposed between the conductive ring and the first exposed pad, wherein the first conductive bridging component is electrically coupled to the conductive ring and the first exposed pad;
wherein, when the operation cover is at the trigger position, the reset conductive components are configured to contact the conductive ring, so that the touch function display panel is triggered through the conductive ring and the first exposed pad.

6. The rotary knob device according to claim 5, wherein the first conductive bridging component is a conductive compression spring.

7. The rotary knob device according to claim 1, wherein the external conductive component includes:
a plurality of second exposed pads disposed on a side surface of the seat away from the operation cover and spaced apart from each other; and
a plurality of second conductive bridging components disposed between the second exposed pads and the contact points, wherein each of the second conductive bridging components is electrically coupled to at least one of the contact points and at least one of the second exposed pads;
wherein, when the operation cover rotates relative to the seat, at least one of the contact points is electrically coupled to one of the second exposed pads through one of the second conductive bridging components.

8. The rotary knob device according to claim 7, wherein each of the second conductive bridging components includes:
a fixing plate fixed on the seat;
a first contact claw extending from the fixing plate toward the annular circuit board, wherein an end of the first contact claw is configured to be elastically abutted against one of the contact points, so that one of the contact points is electrically coupled; and
a second contact claw extending from the fixing plate toward the seat, wherein an end of the second contact claw is configured to be elastically abutted against one of the second exposed pads.

9. The rotary knob device according to claim 1, wherein the braking ring includes a main body, a plurality of through holes, and a plurality of annular posts; wherein each of the through holes extends through the main body along the thickness direction, the through holes correspond in position to a conductive ring of the external conductive component, and the annular posts are respectively sleeved on the through holes; wherein each of the reset conductive components is a dual-headed spring pin fixed on the annular post and passing through the through hole, and a first end of each of a plurality of dual-headed spring pins is configured to be pushed by the conductive trigger component, so that a second end of each of the dual-headed spring pins is electrically coupled to the external conductive component.

10. The rotary knob device according to claim 9, wherein the braking ring further includes a plurality of mounting grooves disposed on the main body, the mounting grooves are adjacent to a corresponding annular post, the elastic components are respectively adjacent to the annular posts, and the elastic components are respectively disposed in the mounting grooves.
